(19) United States
(12) Patent Application Publication
(10) Pub. No.: US 2006/0167606 A1
(43) Pub. Date: Jul. 27, 2006

(54) Electronically controlled mirror system for vehicle blind spot exposure

(76) Inventor: Khaled Malhas, Ann Arbor, MI (US)

Correspondence Address: WHITE-WELKER & WELKER, LLC, P.O. BOX 199, CLEAR SPRING, MD, 21722-0199, US

(21) Appl. No.: 11/113,692

(22) Filed: Apr. 25, 2005

Related U.S. Application Data
(60) Provisional application No. 60/647,699, filed on Jan. 27, 2005.

(51) Int. Cl. G06F 17/00

(52) U.S. Cl. 701/49; 307/10.1

(57) ABSTRACT

A driver leveraging system for moving any vehicle's power side mirror outward in order to sweep and expose a vehicle's blind spot zone designed to work with existing power mirror mechanisms is disclosed. Once engaged, the corresponding power side mirror's Left-Right motor is activated, the mirror surface begins moving outward in a “sweeping” motion, uncovering a wider portion of the adjacent lane containing the vehicle's blind spot zone. Expansion continues to a pre-configured exposure position. Once optimal expansion angle is reached, the Left-Right power mirror motor stops and pauses the mirror in its expanded position for a delay period. The delay period is determined according to a linear function proportional to the vehicle's speed and is calculated in real time by a micro-controller module. The pause at the maximum expansion angle is designed to give the driver enough time to survey the blind spot zone and react safely. While the mirror is in its optimal expansion position, the driver can override the pause period and return timing by keeping the system's button depressed for as long as s/he needs to continue surveying the blind spot zone. When the pause period concludes the system engages the power side mirror's Left-Right motor in reverse motion returning the mirror surface to its original driver-set position. Analog motor controller technology uses coupled digital micro-controllers and proprietary algorithms to consistently and accurately control analog power mirror motors, ensuring that the mirror will reliably return to its original driver-set position despite frequent use.

### CROSS REFERENCE TO RELATED APPLICATIONS

This application claims priority from U.S. Provisional Patent Application Ser. No. 60/647,699, entitled “Electronically Controlled Mirror System for Vehicle Blind Spot Exposure”, filed on Jan. 27, 2005.

### TECHNICAL FIELD OF THE INVENTION

The present invention relates generally to an electronically controlled mirror system that temporarily shifts vehicle mirrors to an alternative viewing angle position. More specifically, the present invention relates to a system for shifting mirror sideview mirror faces from a first position to an alternative wider viewing angle position, pausing, and then returning the first position, with a controlled sweeping motion with respect to time, speed, and angular distance.

### BACKGROUND OF THE INVENTION

Motor vehicles rely on two mirrors mounted on each side of the vehicle to uncover objects (including other vehicles such as passing or trailing traffic) next to them and behind them. These side mirrors are based on a design that is incapable of displaying, or “detecting”, a vehicle occupying a directly adjacent lane and approaching the reference vehicle from the rear (such as the situation of a faster vehicle passing a slower vehicle). As part of basic driving instruction, drivers are often taught to check their blind spot zone before executing a lane change by turning the driver's head by as much as 90 degrees in the direction of the desired lane check/change.

The blind spot phenomenon is pervasive among virtually all passenger cars, light and medium trucks and vans, and all sport utility vehicles. Some medium and heavy-duty vehicles, resort to mounting multiple side view mirrors with varying orientations in order to alleviate this problem.

Many blind spot detection mechanisms used by motorists and described in the prior art embody entirely manual tasks. Such manual techniques to the persistent blind spot problem are inherently flawed and possess several shortcomings.

One shortcoming of prior art systems are that the driver is required to direct his/her direction away from the road ahead. This head turning task is strictly voluntary to the driver. Driver fatigue or low alertness levels often contribute to ignoring or neglecting to perform this manual check when changing lanes.

Another shortcoming inherent with manual techniques is the human perception of sight ahead is based on a concept of continuity. A driver's “Frame Of Reference” (FOR) is a series of continuous images transmitted to the driver's brain from a moving scene ahead. Sudden shifts in a specific scene caused by a swift movement of the head will require additional brain processing time known as Frame Of Reference (herein referred to as “FOR”) Adaptation Time. FOR Adaptation Time in a conventional blind spot check is measured as the time between the driver's head returning back to its original road-facing position after executing a manual blind spot check and the time required by the brain to refocus the scene of the road and traffic ahead including any changes in vehicle movements, new vehicles, road or traffic signals, and road shape. Thus, any system that eliminates or reduces FOR Adaptation Time can provide significant benefits to driver awareness and collision avoidance.

Another well-known problem in the prior art is that vehicle designs vary widely. Some vehicles have severely restricted side view through and behind the driver side B-pillar. This occurs most commonly in some sports cars and convertibles. Similarly, tall SUVs, while having ample viewing room up to the B-pillar on the driver side, have impeded blind spot view due to their relatively large dimensions, mainly height. In essence, any B-pillar or height design issues inherently limit the side and rearward view through the driver's side window. This consequently further limits the reliability and efficiency of conventional blind spot checking mechanisms known in the prior art in preventing avoidable lane change collisions.

Various devices have been devised to cause the side rearview mirrors of a vehicle to scan a blind spot area. Currently, virtually all automotive Original Equipment Manufacturers (hereafter referred to as “OEMs”) utilize analog motors in power side mirror designs. Analog motors are notorious for inaccurate movement when used for a high number of iterations. Thus, many devices taught in the prior art suffer from a failure to return to their preset positions and fail to completely cover the entire blind spot area upon a sweep.

For the foregoing reasons, conventional blind spot detection systems known in the prior are not provided with sufficient means for providing significant benefits in collision avoidance. What is needed is a blind spot detection system that is automated in response to a single driver engagement, provides for blind spot detection, then returns to its normal operating position that is readily adaptable for implementation in any vehicle, regardless of vehicle design, size, or environmental conditions.

### SUMMARY OF THE INVENTION

The present invention is a driver leveraging system for any vehicle's native power side mirror mechanism to move a side mirror outward (away from the corresponding side of the vehicle) in order to sweep and expose the vehicle's blind spot zone. Virtually all-emerging blind spot detection systems known in the prior art rely on an electronic sensing or detection mechanism to alert the driver when an object has entered his/her blind spot zone. Conversely, the present invention is an integrated blind spot exposure system that simply exposes the blind spot zone to the driver using a familiar, ergonomically accepted interface, the vehicle's side mirror.

With the present invention, the driver is empowered to make informed driving decisions based on his/her own assessment of the exposed contents of the blind spot zone. The present invention is designed to work with any existing OEM power mirror mechanism, domestic or import, new or old. Installing the present invention does not require the removal or replacement of any OEM hardware on the vehicle. The present invention is designed to be installed by low-skilled, widely available technicians. The design baseline for the present invention's system mandates that the present invention's system can be installed and configured by an average aftermarket stereo installer.

Once the blind spot exposure system of the present invention is engaged, the corresponding power side mirror's Left-Right motor is activated and the mirror surface begins moving outward (away from the side of the vehicle towards the adjacent lane) in a “sweeping” motion, thereby progressively uncovering a wider portion of the adjacent lane containing the vehicle's blind spot zone. The side mirror's expansion continues up to a pre-configured optimal lane exposure position.

Once the optimal expansion angle is reached, the system of the present invention stops the Left-Right power mirror motor and pauses the mirror in its expanded position for a given delay period. The delay period maybe be either constant and pre-configured in the system, or determined according to a linear function proportional to the vehicle's speed that is calculated in real time by the present invention's micro-controller module. The pause at the maximum expansion angle is designed to give the driver enough time to survey the blind spot zone and react safely.

While the mirror is in its optimal expansion position, the driver can override the pause period by keeping the systems button depressed for as long as s/he needs to continue surveying the blind spot zone. When the pause period concludes the system engages the power side mirror's Left-Right motor in reverse motion and returns the mirror surface to its original driver-set position.

It is an object of the present invention to eliminate the well-known inaccurate movement caused by automotive accessory analog motors when used for a high number of iterations in similar systems taught by the prior art. According to the present invention there is provided an analog motor controller technology that uses digital micro-controllers coupled with a proprietary algorithm to consistently and accurately control analog power mirror motors. This unique implementation ensures that the mirror will reliably return to its original driver-set position every time despite frequent and repeated use. The present invention further ensures that the driver is notified whenever the mirror is not in the original-set position by illuminating a LED light inside the cabin.

The present invention is designed as a universal automotive aftermarket offering with a number of adjustable system parameters to customize the mirror's sweeping motion to individual driver's needs and preference. The system is also capable to optionally integrate with the relevant vehicle's Electronic Control Unit (ECU) in order to digitally obtain real-time vehicle speeds and subsequently dynamically adjust such configuration parameters to ensure greater responsiveness to the driver in different driving conditions. The system is further equipped with a “learn” mode in which it self-determines the correct polarity of the mirror motors along with the correct wiring setup of the host vehicle.

It is therefore an object of the present invention to provide a blind spot detection system that is automated in response to a single driver engagement, provides for blind spot exposure, then returns to its normal operating position that is readily adaptable for implementation in any vehicle equipped with power side mirrors, regardless of vehicle make, model, configuration, origin or size.

In accordance with the present invention, an electronically controlled mirror system for vehicle blind spot exposure is provided and described in detail hereafter.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an aerial view of viewable and blind spot zones next to and behind a vehicle in traffic;

FIG. 2 illustrates the steering wheel mounted controls for engaging the system of the present invention to move the corresponding side mirror outward to visually “sweep” the blind spot zone;

FIG. 3 illustrates the significant expansion in blind spot coverage area that occurs as the system of the present invention activates the sweeping outward mirror movement;

FIG. 4 illustrates the physical component layout and structure of the present invention;

FIG. 5 shows a basic existing OEM power mirror logical circuit design known in the prior art;

FIG. 6 is a logical circuit design depicting how the system of the present invention is integrated with an existing OEM power mirror circuit;

FIG. 7 shows additional components and embodiments of the system of the present invention such as the incorporation of real-time speed acquisition and a Piezo warning speaker;

FIG. 8 is a flow chart schematically showing the principal function of the system of the present invention in controlling the sweeping motion of a vehicle's side view mirror;

FIG. 9 is a flow chart schematically showing the Driver Input Monitoring Loop logic A;

FIG. 10 is a flow chart schematically showing the Power Mirror Expansion Loop of B1;

FIG. 11 is a flow chart schematically showing the Power Mirror Expansion Loop of B2;

FIG. 12 is a flow chart schematically showing the Power Mirror Pause Loop of C;

FIG. 13 is a flow chart schematically showing the Power Mirror Return Loop of D1;

FIG. 14 is a flow chart schematically showing the Power Mirror Return Override Loop of D2;

FIG. 15 is a flow chart schematically showing the exception handling routing of the present invention in the event of that a moving side mirror's movement, due to the invocation of the present invention, encounters any pre-mature end of travel conditions or conflicting controls from the OEM power mirror adjustment controls;

FIG. 16 is an alternative embodiment of the present invention that utilizes wireless control buttons.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, functional, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

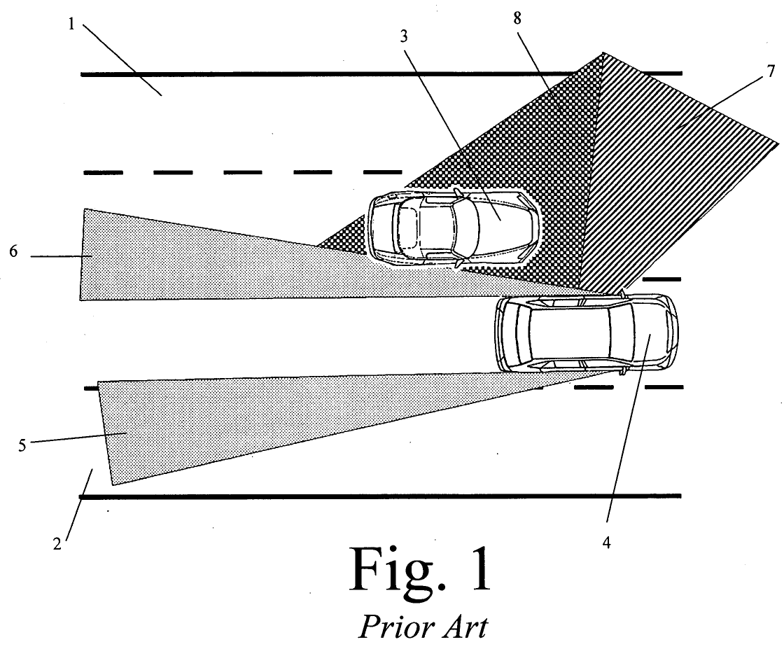

Now referring to FIG. 1, an aerial view of viewable areas next to 7 and viewable areas behind 5, 6 a first vehicle 4, and blind spot areas 8 of a first vehicle 4 travelling in a first traffic lane 2 are illustrated. The overall phenomenon of a second vehicle 3 in an adjacent second lane 1 becoming invisible in a driver's side mirror is known as the “blind spot” or “blind zone.” The location of a traditional blind spot 8 is based on the following factors: the distance of the position of the side mirror to the driver's eyes, the width of the mirror surface, the width of the object behind the reference vehicle (in an adjacent lane), the driver-specified position of the side mirror, and the inflection of the mirror's reflective surface (concave/convex mirror).

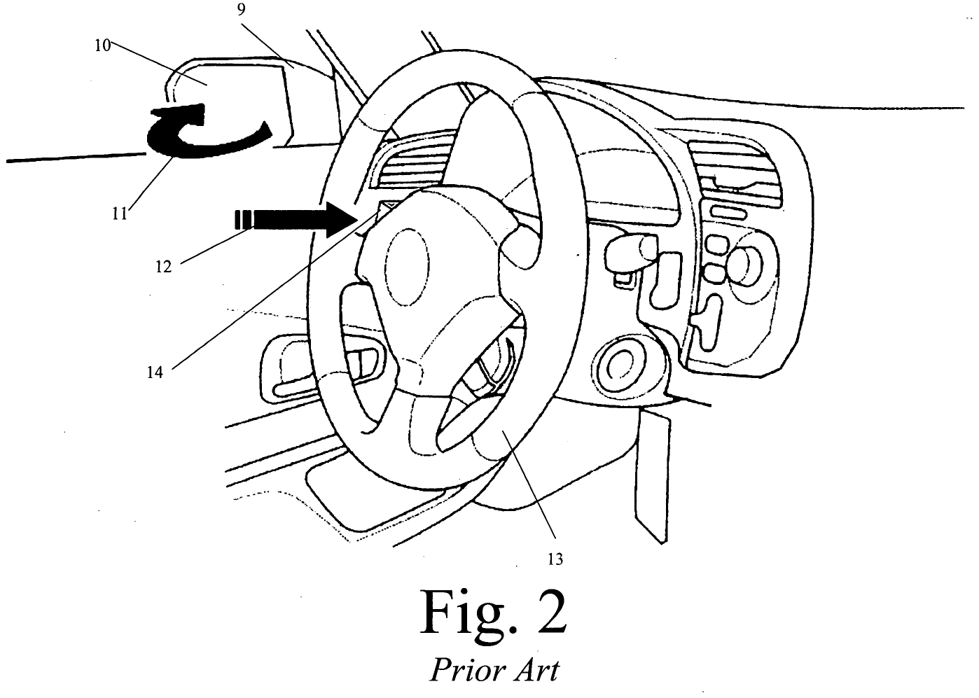

FIG. 2 illustrates the steering wheel 13 mounted controls 14 for engaging the system of the present invention to move the corresponding side mirror 10 outward 11 to visually “sweep” the blind spot zone. In FIG. 2, for simplicity a left-mounted button 14 to control the left side mirror 9 movement is illustrated, but in practice another right-mounted control button to control the right side mirror would be present. To activate the system of the present invention, the driver uses one of the two steering wheels 13 mounted touch or light-click buttons. By engaging the sweeping exposure of the corresponding blind spot at the push of a button 12, drivers can make informed driving decisions without having to turn their heads away from the traffic ahead and without being distracted by a new interface that may require a learning curve or negatively contribute to driver distraction.

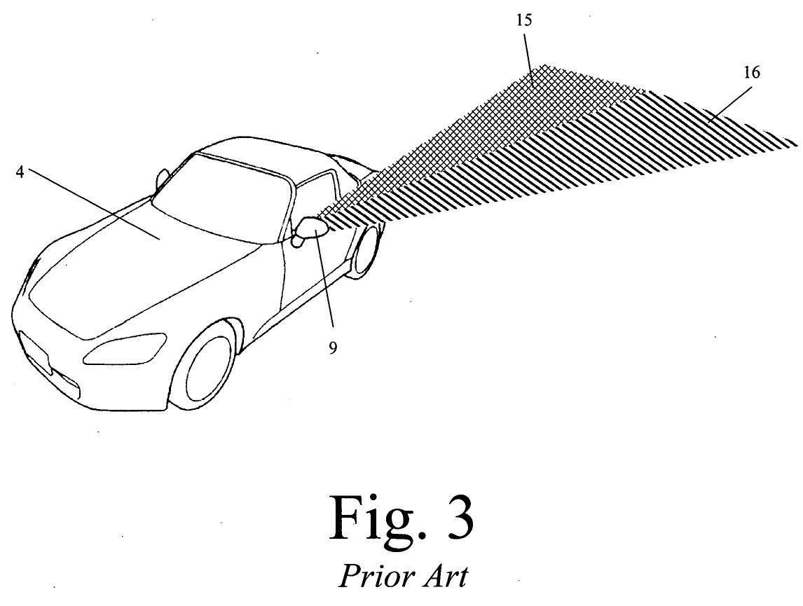

Now referring to FIG. 3, the expansion in blind spot coverage area that occurs as the system of the present invention activates the outward mirror movement is shown for the driver side perspective only. The default rearward visual coverage 15 area provided by a conventional driver side mirror 9 position is significantly increased by expanding the viewable area adjacent to and behind the reference vehicle 4 to reveal and significantly expose all or a useful majority 16 of the blind spot zone by activating the system of the present invention and its corresponding mirror sweep.

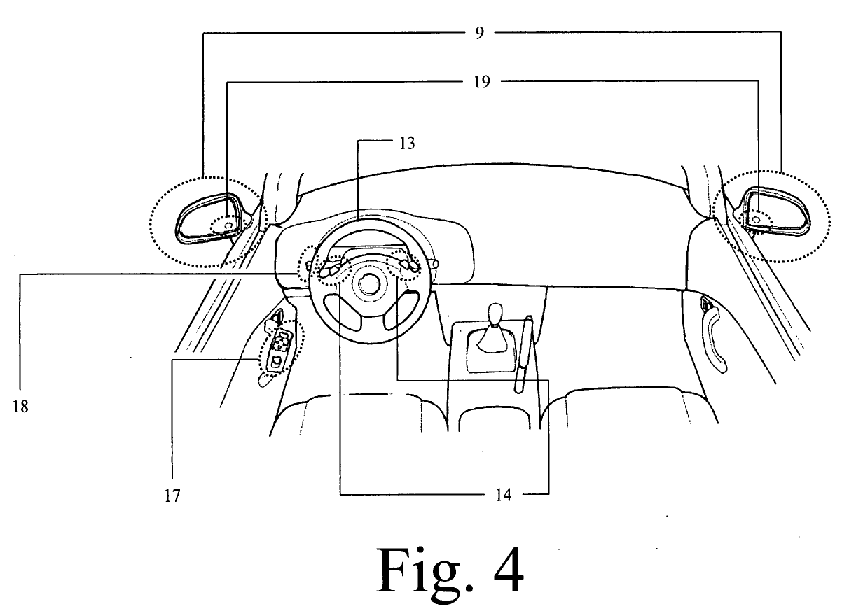

Now referring to FIG. 4, the physical component layout and structure of the present invention is taught. The present invention leverages any vehicle's native power side mirror mechanism to move a side mirror outward (away from the corresponding side of the vehicle) in order to sweep and expose the vehicle's blind spot zone. The system is integrated using a familiar, ergonomically accepted interface: the vehicle's side mirror control 17, and is designed to work with any existing OEM power mirror mechanism, domestic or import, new or old. Installation does not require the removal or replacement of any OEM electrical or mechanical hardware on the vehicle and is designed to be installed by low-skilled, widely available technicians such as an average aftermarket stereo installer.

Existing, unaltered original OEM power side mirror hardware 9, including housing, assembly, chassis, mirror reflective surface and two motors (per side mirror assembly: Left-Right motor and Up-Down motor) are retained in addition to the existing, unaltered original power mirror controller and driver's mirror adjustment pad 17, for both left and right side mirrors. Left and right steering wheel 13 mounted activation soft-click or touch buttons 14 are added. The present invention contemplates an ideal button placement 14 within the reach of one of the driver's extended fingers when the driver's hands are resting on the steering wheel in the “ten-to-two” position or in the racing position.

The backside of the upper spoke of the steering wheel 13 is an optimal and concealed location for the control buttons 14. Ergonomically, such placement allows for immediate access to the control without moving the driver's hand from the steering wheel 13. The driver can reach the desired control button 14 by simply extending the middle or index finger from its normal position of gripping the side of the steering wheel. In addition, this unique placement eliminates the potential contention for space and aesthetics with OEM steering wheel texture, design or controls such as cruise control and stereo buttons.

Not shown in FIG. 4 is the system's micro-controller circuit, which is a self-contained module that includes the system logic along with the additional motor controllers required to move the side mirrors. This module, which description and logical diagram are forthcoming, is an automotive grade embedded circuit board that is intended to be a concealed module that is readily flash-upgradeable.

In an alternative embodiment, a visual LED indicator 19 may be included that is set to the “solid on” state whenever the corresponding mirror is not in its original driver-set position. This indicator is typically on when the system has been triggered and is actively moving the corresponding mirror. Applying various blink patterns to the LED indicator is also used for communicating error or status messages to the driver, such as loss of confidence in the accuracy of the mirror movement due to an environmental error such as a stuck or frozen mirror, or pre-maturely reaching the physical end of travel of a mirror system.

In another alternative embodiment, a simple “Piezo” type or equivalent 42 audio speaker may be added to the base system, which emits a simple audio beep whenever the driver activates the system. The purpose of this one-time audio notification is to further communicate to the drive that the view in the affected mirror is about to change from the original driver-set reflection.

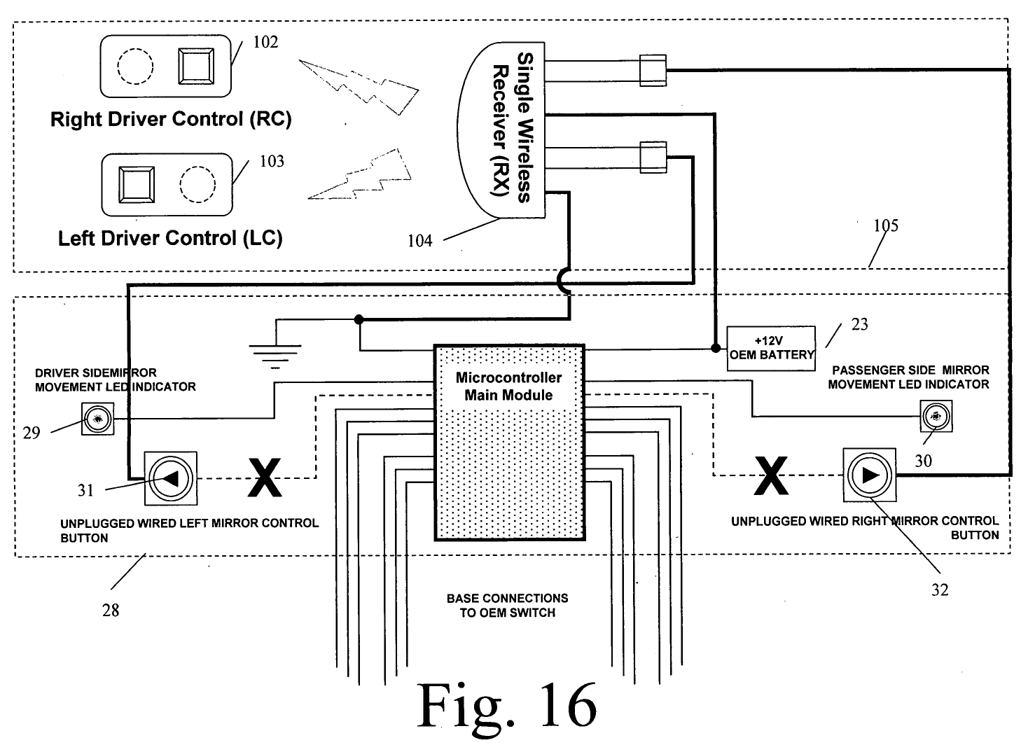

In yet another embodiment, the present invention implementation may include the optional implementation of wirelessly enabled activation buttons, as illustrated in FIG. 16. This implementation further improves the usability and installation ease of the present invention system by eliminating the running and exposure of wires through the steering column.

The proposed technologies for wireless communication between the left and right buttons with the present invention receiver module, mounted under the dashboard, may be any wireless RF communication protocol including, but not limited to, Bluetooth or RFID. Either technology is to be configured to operate within common public bands over a short distance so as to eliminate possible interferences with other OEM wireless communication inside the vehicle's cabin.

The design of the wireless mirror control system 105 comprising the wireless base for the mirror control buttons 102, 103 as well as the wireless signal receiver 104 would be left to a person skilled in the art of wireless communication.

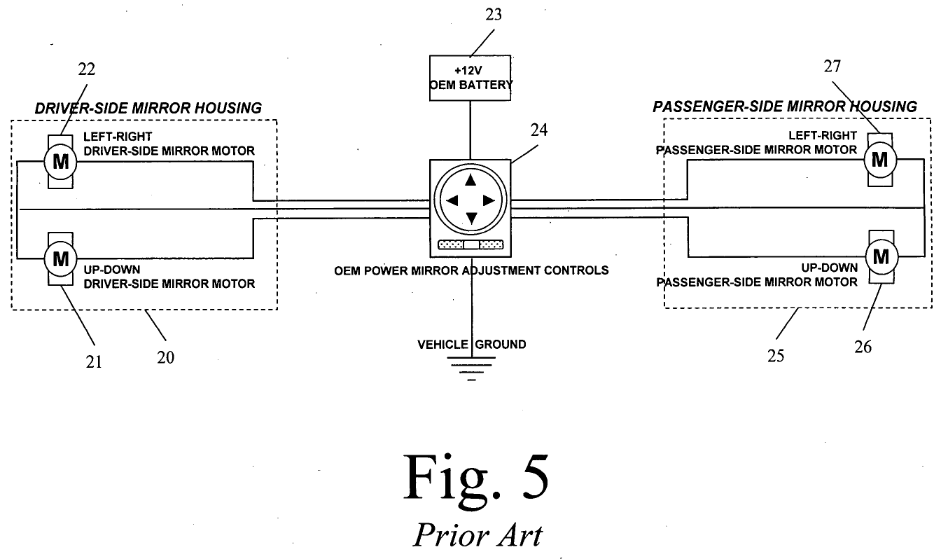

FIG. 5 shows a logical circuit layout of the existing OEM power mirror circuit known in the prior art. The circuit is powered by the OEM power source in the vehicle 23 and is comprised of an OEM power mirror adjustment control 24 that controls both driver-side 21, 22 and passenger-side 26, 27 mirror motors. The driver-side mirror housing 20 contains a Left-Right driver side mirror motor 22 for moving the side mirror in a horizontal plane and an up-down mirror motor 21 for moving the side mirror in a vertical plane. The passenger-side mirror housing 25 contains a Left-Right driver side mirror motor 27 for moving the side mirror in a horizontal plane and an up-down mirror motor 26 for moving the side mirror in a vertical plane.

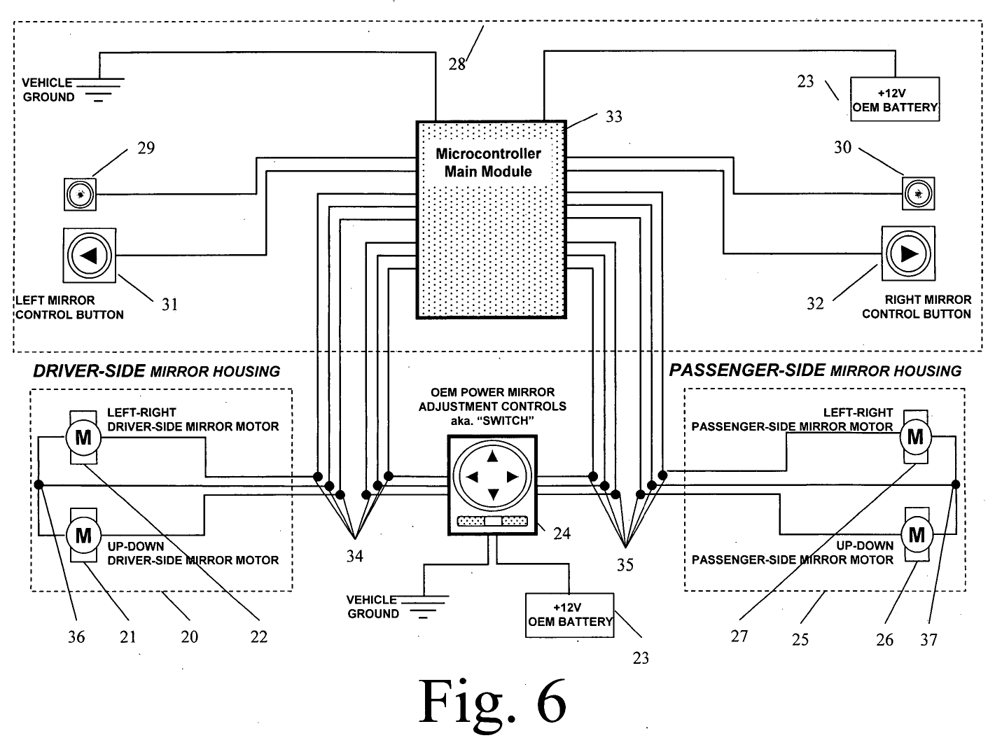

Now referring to FIG. 6, the system of the present invention 28, in its most basic form, is comprised of a micro-controller main module 33, a left mirror control button 31, a right mirror control button 32, a driver side mirror movement LED indicator 29, and a passenger side mirror movement LED indicator 30. The system of the present invention 28 is connected to the OEM power mirror circuit by re-routing the set of three wire connections between the mirror motors and the adjustment switch to the present invention's microcontroller module 33. The re-routing of such connection occurs at locations 34 and 35 between the OEM power mirror adjustment controls 23 and the driver-side and passenger side mirror motors circuitry 36, 37, at a point closest to the mirror motors. Using a proprietary algorithm, the system is capable of entering into a “learn” mode upon installation in order to determine the proper polarity of the driver side and passenger side mirrors 20, 25 along with the correct combination of electrical signals required through each of the mirror's connection wires 34, 35 in order to achieve the desired mirror movement behavior.

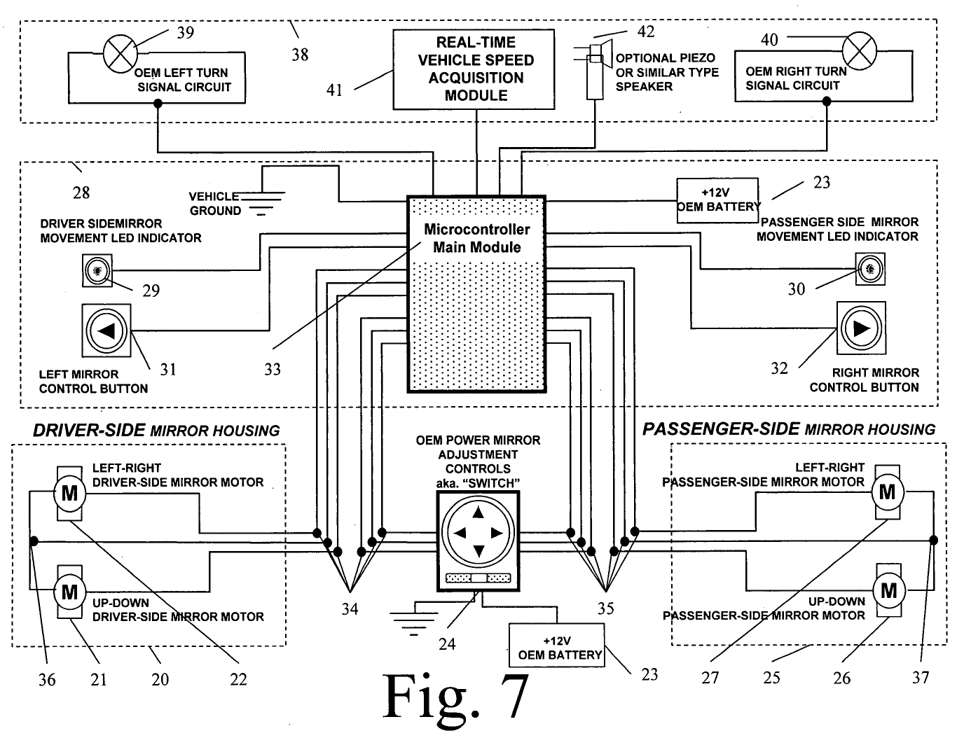

In another embodiment of the system of the present invention, additional optional components 38 can be combined with the base system 28. Such components readily considered and shown in FIG. 7 are a real time vehicle speed acquisition module 41 which enables the present invention's Speed Sensitivity mode, Piezo warning speakers 42, and integration points with the vehicle's turn signal circuits 39 and 40 so as to enable the activation of the present invention in association with engaging the vehicle's turn signal 18.

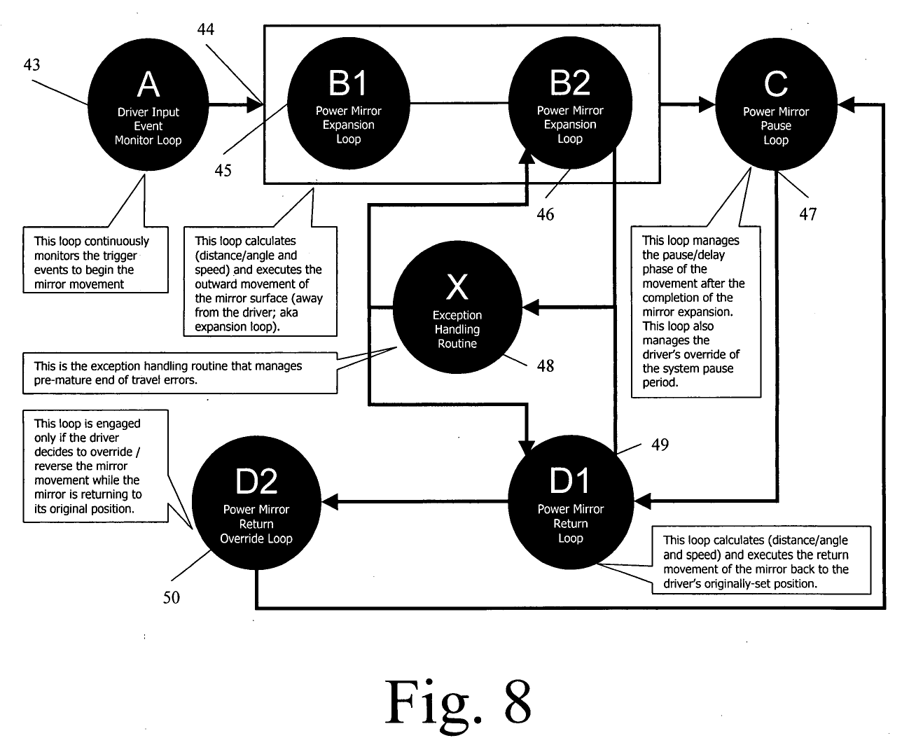

Now referring to FIG. 8, the main circuit logic of the system of the present invention is shown. Module A 43 is the Driver Event Monitor Loop, which continuously monitors for a triggering event in response to which the present system initiates mirror movement. Once a trigger event occurs, the system begins expanding the mirror's angular position as denoted in the Power Mirror Expansion Loop 44 comprising Modules B1 45 and B2 46.

Modules B1 45 and B2 46 are responsible for executing the mirror expansion up to an expansion angle pre-configured in the system to the driver's preference.

Once the optimal expansion angle is reached, Module C 47 dynamically stops the power mirror's Left-Right motor and pauses the mirror in its expanded position for a delay period.

When the pause period of Module C 47 concludes or the activation button 14 is released if it was depressed for a longer period than the system-calculated optimal pause period 79, Module D1 49 executes the return movement of the mirror back to the driver's originally set position by activating the power mirror's Left-Right motor in reverse motion 88.

If at any time during the Module D1 49 return period the driver engages the system by pressing the activation button 14, this action signals to the system 91 that the driver has chosen to override the mirror's return movement and is desirous of sending the mirror back out to its maximum expansion angle. When this occurs, Module D2 50 reverses the mirror motion back out to the maximum mirror expansion point to restart the pause loop of Module C 47.

If at any time during mirror expansion under Modules B1 or B2, or during the mirror return under Modules D1 and D2, the system encounters an abnormal and persistent spike in the current consumed by the circuit, then the system interprets such input as a physical obstacle preventing the movement of the mirror surface. The system considers such an exception as premature end of travel condition of the mirror's surface and the exception handling routing of Module X 48 is triggered. Each of the exception handling routines is aimed at ensuring that the driver is aware at all times when the mirror is not in the position where s/he has set it.

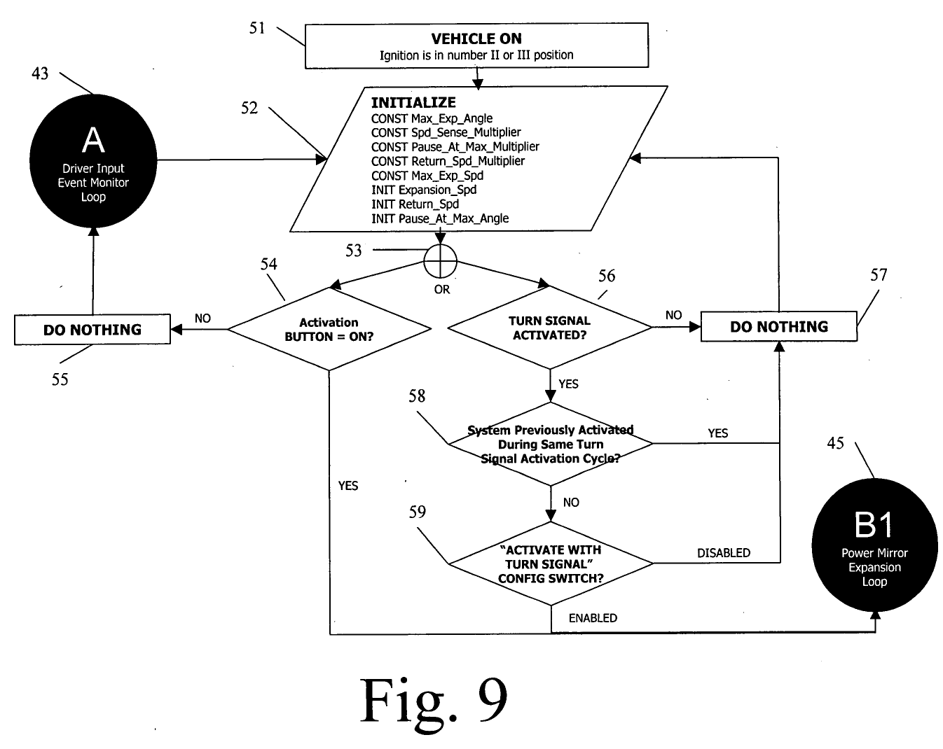

Now referring to FIG. 9, Module A, the Driver Input Event Monitor Loop 43 is explained in detail. The purpose of this continuous loop is to monitor possible activations of the system and dispatch control to the appropriate mirror control module accordingly. Once the vehicle ignition is in the number II on position 51, the system initializes 52 its settings and parameters and begins its Driver Input Event Monitor Loop to continuously await for driver's input 53 in the form of the use of the present invention's activation button 54 or the vehicle's turn signal 56. If neither is activated the system continues to loop by repeatedly in idle state performing no function 55 but repeating its monitoring for potential driver input events 53.

If the Driver Input Event Monitor detects that the driver has depressed an activation button 54, then the system passes control to Module B1 to begin the first phase of the system's mirror movement, the Power Mirror Expansion Loop 45.

If the Driver Input Event Monitor detects that a turn signal is active 56, then the system ensures that the mirror movement cycle had not been initiated during the same activation cycle of the turn signal 58. If a system mirror movement cycle had been executed previously during the same turn signal activation period, the system takes no action, 57 and returns control to the top of the Driver Input Event Monitor loop. This step is an important safeguard against the possibility of multiple invocations of the system's mirror movement mechanism in response to a single activation of the corresponding turn signal by the driver. Secondly, the system checks for the system configuration parameter that enables/disables the system's activation in response to the engagement of a turn signal 59. If the “move mirror on turn signal activation” configuration parameter is set in the system to no, then the system takes no action, 57 and returns control to the top of the Driver Input Event Monitor loop. Otherwise if the “move mirror on turn signal activation” configuration parameter is found to be set yes, then the system passes control to Module B1, the Power Mirror Expansion Loop 45 in order to begin the first of a three phase system mirror movement cycle (expansion, pause and return).

Upon detection of an activating event during the driver input monitor loop of Module A 43, the system enters the first phase of the total system cycle, the outward mirror expansion movement. The expansion movement is comprised of Module B1 45 of the Power Mirror Expansion Loop which is responsible for calculating and acquiring the correct mirror motor movement parameters and of Module B2 46 which is responsible for executing and controlling the mirror motor thereby achieving the desired outward expansion of the mirror surface.

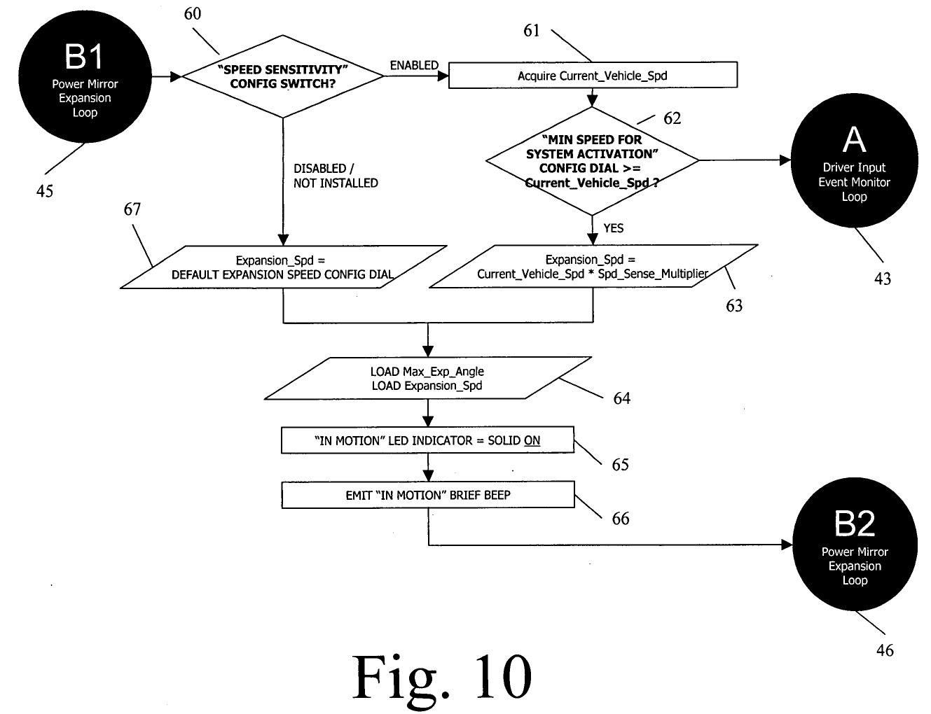

FIG. 10 denotes the Power Mirror Expansion Loop initialization phase as shown in Module B1 45. To begin the calculations and data acquisition required prior to executing mirror movement, the system must first determine whether the Speed Sensitivity configuration parameter is enabled in the system 60. If Speed Sensitivity mode is disabled or not installed 67, the system proceeds to acquire the default mirror expansion speed from a pre-configured value in the system 67.

If Speed Sensitivity is enabled in the system 60, then the next step in Power Mirror Expansion Loop is to acquire the current vehicle speed 61. The vehicle speed acquisition module 41 is used to obtain a real-time reading of the vehicle's continuous digital speedometer values. Once vehicle speed has been acquired, the system next determines if a minimum speed threshold has been reach to activate the system 62. The minimum speed threshold value for activation of Speed Sensitivity mode is a configurable default parameter in the system. If the minimum speed threshold has not been reached, the system will not execute mirror movement and return to Module A 43 to further monitor and await driver input events. If the threshold has been met, the system will then calculate the required mirror expansion speed as the product of the vehicle's real-time speed 63 multiplied by a mirror expansion speed factor pre-configured in the system so as to result in mirror expansion speed that is linearly proportional to the vehicle's speed. Thus, the mirror's expansion speed is faster at higher vehicle speeds.

Once the mirror expansion speed calculation/acquisition is complete, the system further retrieves the system pre-configured value of the maximum expansion angle and loads all parameters in the expansion loop to begin execution 64. Typically the optimal expansion angle for uncovering the driver-side blind spot zone for average passenger vehicles is between +8 to +14 degrees from the driver's originally set left side mirror position, with some full-size sport utility vehicles and trucks requiring as much as +22 degrees to reach the optimal expansion angle. Prior to executing mirror movement, the system sets the “in motion” LED indicator to solid “ON” state 65 and emits a brief audible beep to signal beginning of mirror motion 66, if the optional audio speaker device is installed.

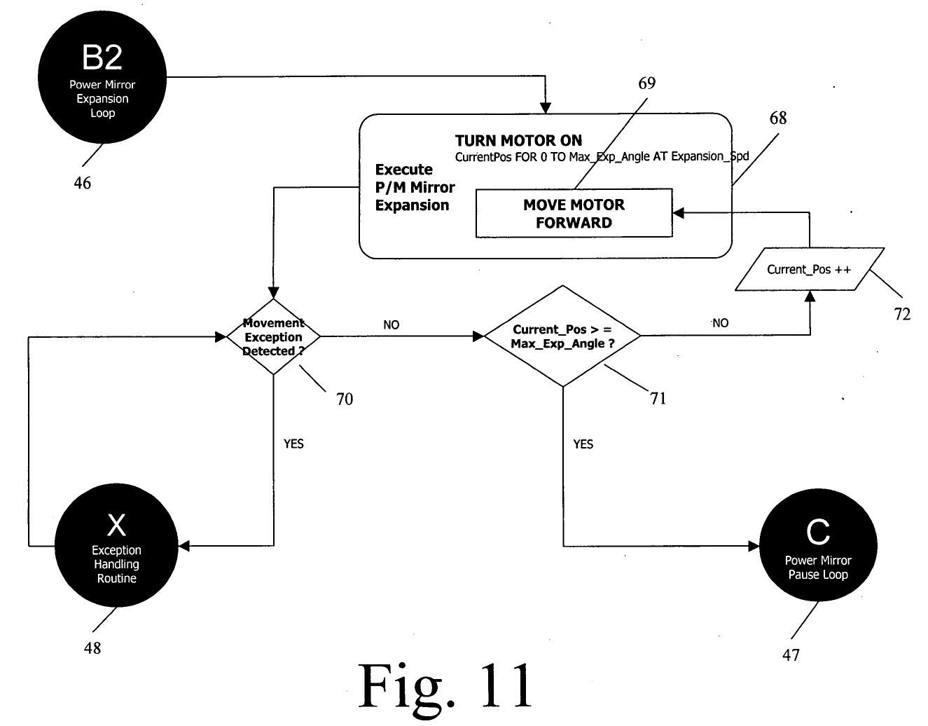

In Module B2 of the Power Mirror Expansion Loop 46 as shown in FIG. 11, the system executes a loop that activates the mirror's Left-Right motor in the forward direction 69 by applying the proper voltage in the correct polarity. The mirror movement is executed as a series of forward motor movement steps monitored by an encoderless position counter. The position counter is incremented continually 72 until it reaches a value equivalent to the maximum expansion angle 71. Once the maximum expansion angle position is reached, the system passes control to the second major phase of the system mirror movement cycle: Module C Power Mirror Pause Loop 47.

During the execution of mirror expansion, the system continually monitors for any movement exceptions 70. If such an exception is detected, the system is then directed to the Exception Handling Routine of Module X 48.

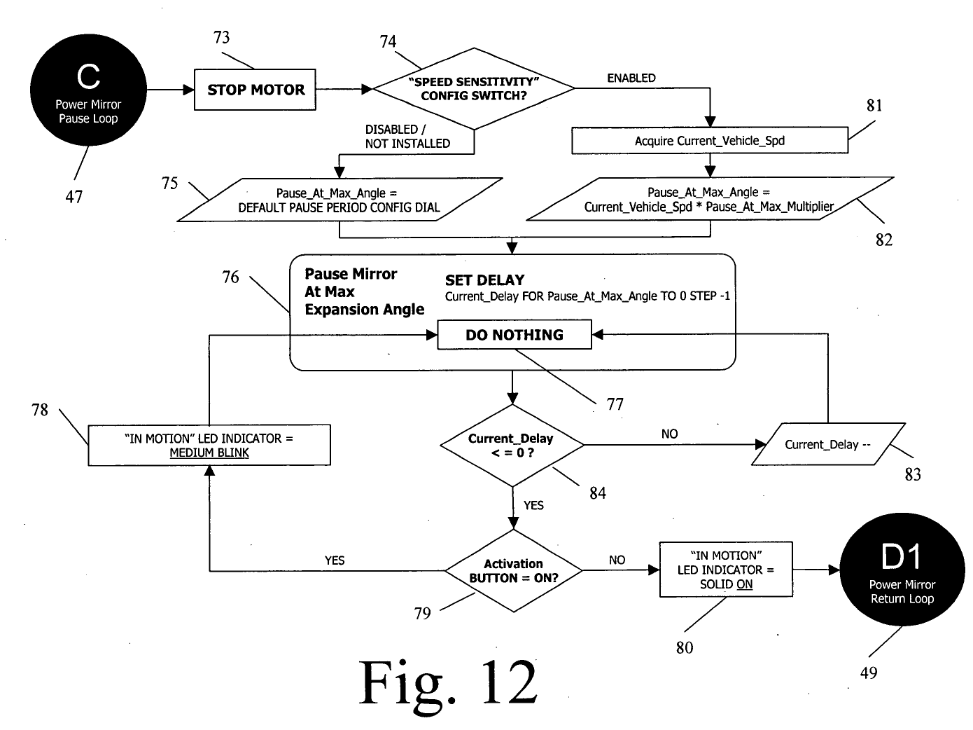

Once Module C Power Mirror Pause Loop takes control of the mirror movement 47 as shown in FIG. 12, it immediately stops the mirror's Left-Right motor 73 using the dynamic motor braking method to reduce the possibility of unintended motor coasting. Then the system proceeds to either retrieving or calculating the required delay with which to pause the mirror at its current maximum expansion position. The pause at the maximum expansion angle is designed to give the driver enough time to survey the blind spot zone and react safely. In order to determine the required delay in this phase, the system begins by checking whether the Speed Sensitivity mode is enabled 74. If Speed Sensitivity mode is disabled or not installed 67, the system proceeds to acquire the default mirror pause period from a pre-configured value in the system 75.

If Speed Sensitivity 74 is enabled, the duration of the pause period is calculated in real-time based on a factor of the vehicle's speed 81. The system acquires the current vehicle speed 81, calculates the proportional pause period 82, and sets the delay 76. Using the Speed Sensitivity mode, the optimal pause period is calculated as the product of the vehicle's real-time speed 82 multiplied by a pause period factor pre-configured in the system so as to result in a mirror pause period that is inversely proportional to the vehicle's speed. Thus, the pause period is shorter at higher vehicle speeds. For example, a sample pause period maybe calculated by the system's micro-controller module using the linear function inversely proportional to the vehicle's real-time speed starting with a baseline of 1.5 seconds at a vehicular speed of 55 mph or lower, with increasingly shorter delays as the vehicle speed increases to ensure greater responsiveness to the driver.

Once the delay has been set 76, the system begins a countdown timer loop that is initialized at the determined delay period. As the timer engages, the system checks to see if the current delay period has concluded. This is achieved be decrementing the countdown delay counter 83 until it reaches zero 84.

Once the delay period has elapsed, the system checks to see if the corresponding system activation button is depressed 79. If the corresponding activation button is not depressed at the time of conclusion of the delay period, then the system continues to leave the in motion LED indicator in a solid “ON” state 80 and moves to the third and final phase of the system's mirror movement cycle: Module D1 Power Mirror Return Loop 49.

If at the conclusion of the delay period 84, the system detects that the corresponding activation button is still depressed 79, the system interprets this continued activation as an indication of the driver's desire for additional time to survey the reflected view in the mirror at its maximum expansion position. This pause period override is handled by the system by first setting the in motion LED indicator to a medium blink state 78. Secondly, the system enters a do nothing loop until the release of the corresponding activation button is detected 79. The release of the depressed activation button is a signal to the system to resume the normal behavior of the system by moving to the next phase of the mirror movement cycle. At such point, the system resets the LED indicator to solid “ON” state 80 and moves to Module D1 Power Mirror Return Loop 49.

When the pause period of Module C 47 concludes or the activation button 14 is released if it was depressed for a longer period than the system-calculated optimal pause period 79, Module D1 49 executes the return phase of the mirror movement cycle back to the original driver-set position by activating the power mirror's Left-Right motor in reverse motion 88.

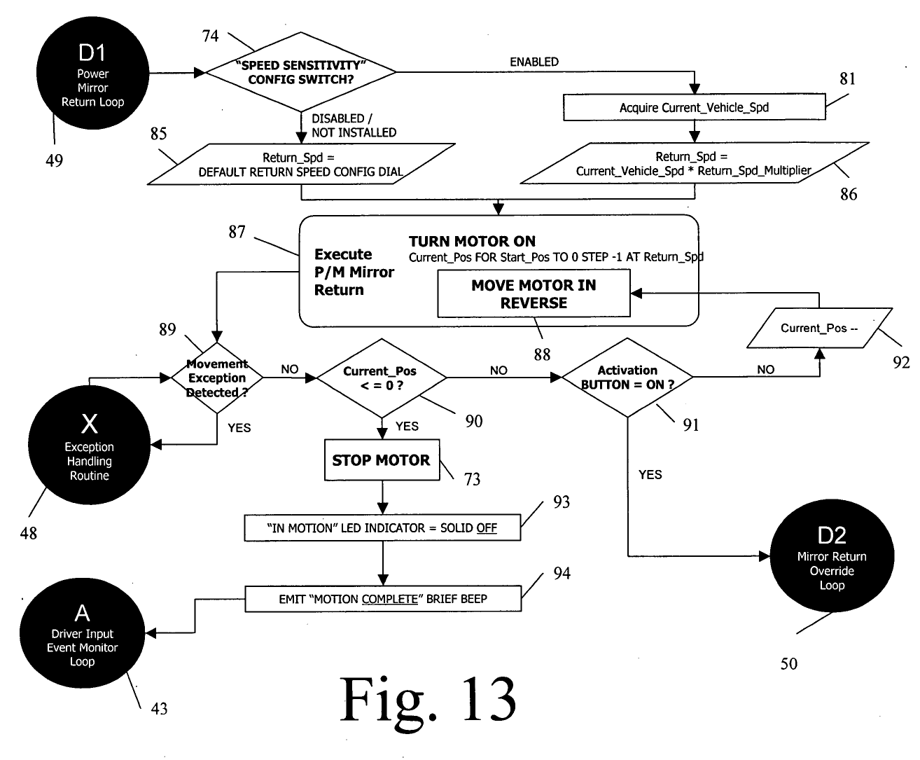

FIG. 13 illustrates the steps of Module D1 49, the Power Mirror Return Loop. In step 74, the first decision in mirror return is to determine if Speed Sensitivity mode is active. If Speed Sensitivity mode is disabled or not installed, the system proceeds to acquire the default mirror return speed from a pre-configured value in the system 85.

If Speed Sensitivity is enabled in the system 74, then the next step in Power Mirror Return Loop is to acquire the current vehicle speed 81. The vehicle speed acquisition module 41 is used to obtain a real-time reading of the vehicle's continuous digital speedometer values. The vehicle speed-readings obtained 81 is distinct from the speed readings acquired during the expansion and pause phases that are acquired separately and only at the time of initiation of the respective phase. This finer granularity in vehicle speed acquisition ensures that each movement phase is reacting the to the instantaneous needs of the driver in a dynamic and responsive fashion, not using outdated readings of the vehicle's speed.

Once vehicle speed has been acquired, the system then calculates the mirror return speed as the product of the vehicle's real-time speed multiplied by a mirror return speed multiplier 86 pre-configured in the system. This calculation is intended to produce mirror return speed that is linearly proportional to the vehicle's speed. Thus, the mirror returns to its original driver-set position faster at higher vehicle speeds.

Once the mirror return speed calculation/acquisition is complete, the system further retrieves the value of the position of the maximum expansion angle reached during the execution of the Power Mirror Expansion Loop 68 in Module B2 46. All return movement parameters are then loaded and the system activates the Left-Right motor in the reverse direction 88 by applying the proper voltage in the correct polarity. The mirror movement is executed as a series of reverse motor movement steps monitored by an encoderless position counter. The position counter is initially set to equal the maximum expansion position reached during the mirror expansion phase and is decremented continually 92 until it reaches a value of zero indicating that the mirror has reached its original starting position 90.

During the execution of the return movement, the system, in addition to moving the Left-Right motor in the reverse direction, performs the following three concurrent tasks that are unique to the return phase of the overall mirror movement cycle:

The first concurrent task is the ongoing return motor movement correction (not shown): In this task, the system performs additional voltage manipulations in order to compensate for the inherent inaccuracies in analog motor movement and any torque differential encountered due to varying resistance or slack in the power mirror chassis assembly. To do so, the system segments the return movement into discrete and short time intervals, typically less than 100 milliseconds.

In each discrete time interval, the system monitors current consumption differential with respect to the same time interval during the expansion phase. The current differential is used as the key metric to monitor differential in physical resistance encountered by the motor during the return phase that was not encountered during the expansion phase. The system consequently calculates the amount of voltage offset needed to augment the regular voltage amount applied to the motor.

If the algorithm discerns that at a particular discrete time interval the motor is encountering greater physical resistance than it did in the same interval during the expansion phase, then voltage is increased proportionally and the motor speed is increased to compensate for the increased physical resistance. Conversely, if the algorithm discerns that at a particular discrete time interval the motor is encountering less physical resistance than it did in the same interval during the expansion phase, then voltage is decreased proportionally and the motor speed is decreased to compensate for the relative decrease in physical resistance. In this task, the system also performs the background calculation of the theoretical induced voltage for an upcoming discrete time interval in order to prevent the possibility of upwardly or downwardly spiraling runaway voltage. This proprietary mirror return algorithm is a critical feature of the present invention as it serves to substantially improve the usability as well as risk worthiness of its commercial derivatives.

The second concurrent task to occur during the mirror return phase motor movement loop is the continuous checks to detect abnormal physical mirror movement exceptions 89. Such exceptions arise from monitoring disproportionately high and persistent spikes in mirror motor's current consumption. If such an exception is detected, the system is then directed to the Exception Handling Routine of Module X 48.

The third concurrent task to occur during the mirror return phase motor movement loop is the continuous monitoring of the system's corresponding activation button. If the activation button is depressed at any time during the mirror return phase movement 91, then the system interprets such input that the driver is desirous of re-examining the reflected mirror view at its maximum expansion angle and as such cedes control to Module D2 Mirror Return Override Loop 50.

Returning to the mirror return movement underway 88, the system continually checks the position counter to determine if it has reached the mirror's original position at the time of system activation 90. If such point has not been reached, the system decrements the position counter 92 and continues additional motor movement in the reverse direction 88. Once the position counter reaches zero, the system recognizes that the mirror has reached its original driver-set position. At this point, the system stops the motor 73, turns the in motion LED indicator to a solid “OFF” state 93, and it emits a motion complete audio beep 94 if the audio speaker device is installed. At the conclusion of the return movement, the system turns control back to Module A Driver Input Even Monitor Loop 43 to await the driver's activation of a new system cycle.

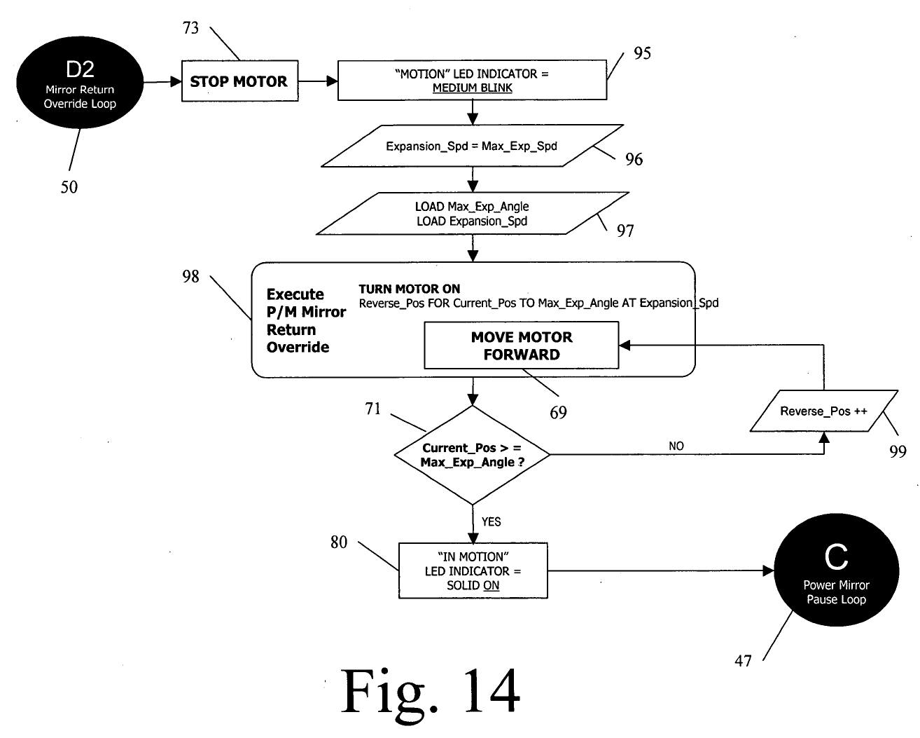

Now referring to FIG. 14, the Module D2 50 Mirror Return Override Loop is disclosed. If at any time during the Module D1 Power Mirror Return Loop's 49 return period the driver engages the system by depressing the activation button 14, this action signals to the system 91 that the driver has chosen to override the mirror's return movement and is desirous of sending the mirror back out to its maximum expansion angle. In this case, the system will immediately stop the motor 73, set the in motion LED indicator to a medium blink state 95, and calculates the required differential in mirror re-expansion 96 based on how much of the overall return movement the mirror had completed as part of the original return loop. The required mirror re-expansion distance is expressed as the differential between the mirror motor return loop counter value and the maximum expansion angle counter value 98. The system also assigns the mirror speed for this re-expansion phase as the maximum speed 97 allowable in the system to ensure responsiveness to the driver's wishes. Once the recalculations and movement parameter values have been loaded into the re-expansion loop, the system will then reactivate the Left-Right motor 98 to move the motor forward in an outwardly direction 99 while continually monitoring the mirror's re-expansion position 71 using a mirror re-expansion position counter. The system continues the re-expansion loop 69 while checking to determine if the current re-expansion position has reached the maximum expansion position as defined in Module B2 Power Mirror Expansion Loop 71. Once the re-expansion movement has concluded, the system sets the in-motion LED indicator to a solid “ON” state 80 and the system returns control to Module C Power Mirror Pause Loop 47.

The system's exception handling routines are aimed at ensuring that the driver is aware at all times when the mirror is not in the position where s/he has set it.

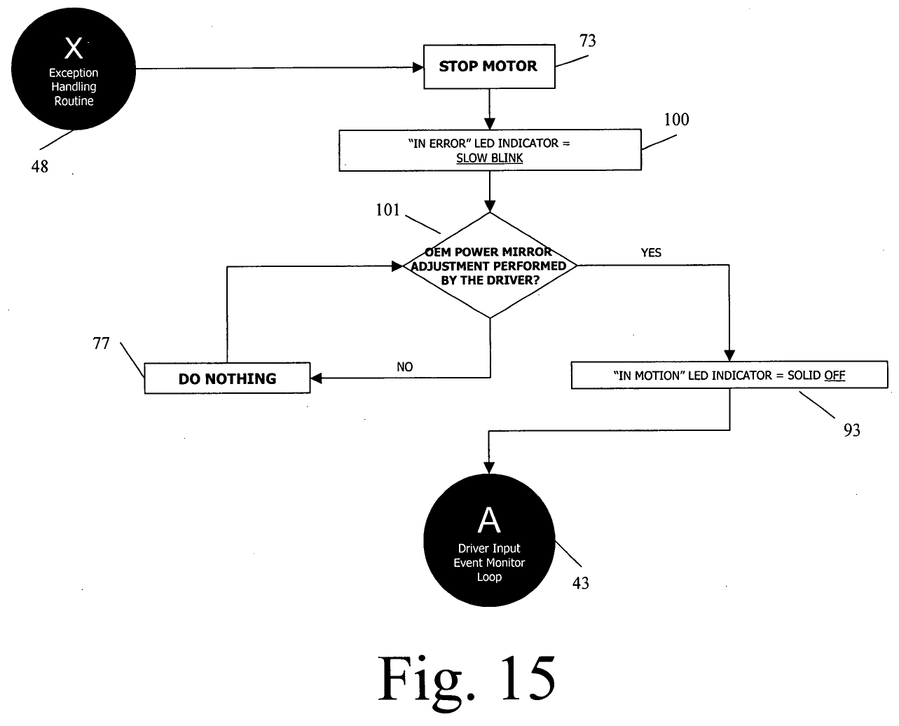

If at any time during mirror expansion under Modules B1 45 or B2 46, or during the mirror return under Module D1 49, the system encounters an abnormal and persistent spike in the current consumed by the mirror motor, then the system interprets such input as a physical obstacle preventing the movement of the mirror surface from proceeding freely. This obstacle can be the actual end of travel of the mirror chassis, or an external environmental condition such as a frozen or stuck mirror surface. When this exception is detected, the system transfers control to Module X Exception Handling Routine 48. As shown in FIG. 15. the first step in pre-mature end-of-travel exception handling is to immediately disconnect power to the motor to prevent overloading 73. Then the system sets the LED indicator in a special error blink pattern state 100 and rests in place in a continuous do-nothing loop 77. The persistent do-nothing error state can only be reset when the driver readjusts the mirror 101 using the OEM power mirror adjustment controls 24.

The second type of exception handling (not shown) is designed to self-examine the system's movement calculations on an ongoing basis. If the system detects inconsistencies in the calculations of the current or eventual position of the mirror surface, then the system sets the LED to a constant medium blink pattern 100 signaling to the driver that the system no longer has confidence in either the current position of the mirror surface or that the mirror would reliably return to its driver-set original position at the conclusion of the present mirror movement cycle. In such a case, the system activates the LED in a medium blink pattern and rests in place in a continuous do-nothing loop 77. The persistent do-nothing error state can only be reset when the driver readjusts the mirror 101 using the OEM power mirror adjustment controls 24. This proprietary mirror return logic is a critical feature of the present invention as it serves to substantially improve the reliability and risk worthiness of its commercial derivatives.

The third type of exception handling (not shown) is if the system detects that the driver is attempting to adjust a power mirror using the OEM power mirror adjustment controls 24 while said mirror motor is currently under the control of the present invention. In this event, the system immediately cedes control to the OEM power mirror adjustment circuit thereby eliminating the potential of overloading the affected power mirror motor and ensuring that the overall system's base frame of reference is adjusted to the driver's newly-set position of the mirror.

The present invention's circuit is designed to overcome the pervasive inconsistencies that are inherent to the movement of OEM's analog motors. As described above, the present invention contains an advanced algorithm that ensures that the angular distance, not elapsed time, traveled by the mirror during the return phase is the same as the angular distance traveled by the mirror on its way out to the maximum expansion angle. This algorithm is based on measuring both current and voltage applies to the motor in its expansion phase and comparing each discrete time interval's current consumption during the return phase to its corresponding equivalent during the expansion phase. The current differential signals a difference in torque encountered. The system subsequently applied an adjusted induced voltage to the return movement for the same discrete time interval in order to modulate the motor speed and consequently equalize the angular distance traveled. This algorithm has been design specifically for supporting the desired angular movement accuracy of the present invention. This approach and associated algorithm do not require the addition of any physical sensors or encoders to the power mirror enclosure or baseline circuit.

The present invention is designed to adapt its mirror movement to the driver's driving style. This is accomplished using an add-on Real-Time Vehicle Speed Acquisition Module that performs continuous acquisition of the vehicle's speed either through direct integration to the vehicle's ECU or through an alternative aftermarket digital speedometer device. The design of this component is left to anyone skilled in the art of digital real-time speed capture.

Using the real-time speed reading as an input, the present invention's micro-controller may control: the speed of the mirror expansion movement, the duration of the pause period at maximum expansion angle, and the speed of the mirror return movement.

Each of the preceding movement parameters is calculated by the system's micro-controller based on the phase's separate real-time vehicle speed-reading using speed and time delay multipliers. Such multipliers serve as the default movement values when the Speed Sensitivity mode is disabled or not installed. Each of such values may be configured in the present invention at the time of system installation The present invention may use any of three specific algorithms to determine the speed of movement of mirror surface along with its associated pause period at the maximum expansion angle. Each such algorithms provides the system user with the “sweeping” behavior that is consistent with how drivers are trained to span their blind spot zone in search of impeding objects.

The first algorithm is the Constant Mirror Movement algorithm. In this model, all mirror movement parameters are configured once at the time of installation of the present invention system. Application of this algorithm produces the standard of the present invention's mirror sweeping motion and is the basis for mirror movement if the Speed Sensitivity mode is disabled, not installed, or enabled but a minimum speed threshold has not been breached.

The second algorithm is the Dynamic Sweeping Mirror Movement algorithm. In this algorithm, the dynamic sweeping effect is realized by the engagement of Speed Sensitivity mode and the real-time calculation of each of the system's movement parameters according to the following equations:
mirror speed (expressed in applied voltage and duration)=(real-time vehicle speed reading×speed multiplier); and
pause period at maximum expansion angle (in time)=(pause multiplier/real-time vehicle speed reading).

The third mirror movement algorithm is the “Sling Shot” Sweeping Effect Movement wherein the speed of the mirror surface during the expansion phase, or return phase, is fastest moving away from the origin, decreasing asymptotically to it slowest speed as it reaches the maximum expansion angle position, as illustrated by following speed curve and can be expressed by the following formula:
mirror speed=speed multiplier×LN((mirror position to max expan angle+1)−current mirror position).

The following alternative expression may also be used: v=(spd_mult×LN ((max_motor_revs_to_exp_angle+1)−x); where x is the current number of revolutions moved by the motor or an equivalent unit that governs mirror movement.

[image]

The threshold for engagement of Speed Sensitivity is also optionally configurable at installation such that:

IF (real-time vehicle speed reading<default configured minimum speed for system engagement) THEN speed multiplier=1. This threshold is set at zero in all implementations of the present system in which Speed Sensitivity is disabled or not installed.

It is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention. Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A system for controlling electric mirror movement in a vehicle for blind spot exposure wherein:
depressing one of two steering wheel mounted buttons in order to activate the mirror movement mechanism wherein there is a left button to control the driver side mirror and a right button to control the passenger side mirror;
the mirror movement mechanism controls the corresponding side's power mirror motor by moving it in an outwardly direction away from the corresponding side of the vehicle;
the mirror is expanded to a maximum expansion angle;
once the mirror surface reaches the maximum expansion angle, the mechanism pauses the mirror in order to allow sufficient time for the driver to view the exposed blind spot zone's contents;
once the pause period concludes the mirror movement mechanism engages the same power mirror's motor in the reverse direction thereby retracting the mirror surface to its original driver-set position; and
while the system is retracting the mirror back to its original position, the corresponding button may be repressed at any time in order to reverse the movement and resend the mirror back out to the maximum expansion angle position.

2. The system for controlling electric mirror movement in a vehicle for blind spot exposure of claim 1 wherein,
the maximum expansion angle is adjustable and pre-configured;

3. The system for controlling electric mirror movement in a vehicle for blind spot exposure of claim 2 wherein, the maximum expansion angle varies from 8 degrees to 22 degrees.

4. The system for controlling electric mirror movement in a vehicle for blind spot exposure of claim 1 wherein the pause period is an adjustable and configurable parameter.

5. The system for controlling electric mirror movement in a vehicle for blind spot exposure of claims 1 or 3 wherein, additional time for the pause period may be obtained by depressing the corresponding button for any desired period of time.

6. The system for controlling electric mirror movement in a vehicle for blind spot exposure of claim 1 wherein, an advanced algorithm, measuring both current and voltage applied to the motor in its expansion phase and calculating the amount of current and duration required for the return phase, ensures that the distance traveled by the mirror during the return phase is the same as the distance traveled by the mirror during the expansion phase, comprising:
an advanced algorithm that ensures that the angular distance, not elapsed time, traveled by the mirror during the return phase is the same as the angular distance traveled by the mirror on its way out to the maximum expansion angle;
in said algorithm, the present invention stores the current consumption figures across all discrete time intervals comprising the expansion phase of the mirror movement;
said algorithm based on measuring both current and voltage as applied to the motor in its expansion phase and comparing each discrete time interval's current consumption during the return phase to its corresponding equivalent during the expansion phase;
subsequently and proportionately modulating the voltage applied to the return movement for the same discrete time interval in order to relatively compensate for slowed or hasted motor movement; and
said algorithm that further calculates theoretical induced voltage during a return phase discrete time interval in order to safeguard from runaway voltage reduction or amplification.

7. The system for controlling electric mirror movement in a vehicle for blind spot exposure of claim 1 wherein, the micro-controller may use mathematical algorithms to determine the speed of movement of mirror surface, each of which provides a sweeping mirror surface.

8. The system for controlling electric mirror movement in a vehicle for blind spot exposure of claim 7 wherein,
a real-time Speed Sensitivity module acquires the vehicle's speed;
the real-time speed-reading is an input value used by a micro-controller;
the micro-controller enables mirror movement if the speed reading is above a set speed threshold; and
the micro-controller uses speed multipliers for a real-time calculation to control the mirror speed of the expansion phase, the mirror speed of the return phase, and the duration of the pause period at maximum expansion angle.

9. The system for controlling electric mirror movement in a vehicle for blind spot exposure of claim 8 wherein an algorithm for producing a constant linear mirror sweeping motion is utilized.

10. The system for controlling electric mirror movement in a vehicle for blind spot exposure of claim 8 wherein an algorithm for producing a dynamic sweeping mirror motion is based on the real-time speed-reading and speed multipliers.

11. The system for controlling electric mirror movement in a vehicle for blind spot exposure of claim 8 wherein an algorithm based on the real-time speed reading for producing a non-liner sweeping mirror motion produces a moving mirror surface which is:
fastest moving away from its origin, decreasing asymptotically to a slowest speed, as it reaches the maximum expansion angle during the expansion phase; or
fastest moving away from its maximum expansion angle, decreasing asymptotically to its slowest speed, as it reaches the driver-set original position of the mirror during return phase.

12. The system for controlling electric mirror movement in a vehicle for blind spot exposure in claims 10 or 11 wherein an algorithm for producing a constant linear mirror sweeping motion is utilized unless the real-time vehicle speed is above a minimum threshold speed value pre-configured in the system.

13. The system for controlling electric mirror movement in a vehicle for blind spot exposure in claim 1 wherein the normal 12-volt application to the power mirror motor is increased up to 32 volts.

14. The system for controlling electric mirror movement in a vehicle for blind spot exposure in claim 1 wherein exception handling routines monitor for the two following critical exceptions to mirror movement:
whenever the mirror surface is immovable due to any external reason; and
any premature end-of-travel condition
if one of these exceptions occurs, the motor controllers instantly stop the motor and then cede control to the appropriate exception handling routine.

15. The system for controlling electric mirror movement in a vehicle for blind spot exposure in claim 1 including a visual signal device comprising an integrated LED indicator.

16. The system for controlling electric mirror movement in a vehicle for blind spot exposure in claim 15 wherein the LED indicator has the following states:
a solid ON mode whenever the corresponding mirror is not in the driver's originally set position;
a medium-blinking mode whenever the driver overrides the mirror's pause period at maximum expansion angle which then returns to the solid ON state when the driver releases the present invention's button;
a constant slow blinking mode whenever an exception in the mirror movement is detected until mirror position is readjusted using the vehicle's power mirror adjustment controls;
or a constant OFF state.

17. The system for controlling electric mirror movement in a vehicle for blind spot exposure in claim 1 including a learn mode in which, upon system's installation, the system's microcontroller:
learns the proper polarity of each of the host vehicle's mirror motors; and
determines the proper combination of vehicle electrical lines through which to send the correct electrical signal to the desired motor.

18. The system for controlling electric mirror movement in a vehicle for blind spot exposure in claim 1 wherein the vehicle's turn signal may also be used to activate the mirror movement.

19. The system for controlling electric mirror movement in a vehicle for blind spot exposure in claim 8 wherein only said buttons or the use of the vehicle's turn signal may activate mirror movement if a minimum speed threshold has been breached.

20. The system for controlling electric mirror movement in a vehicle for blind spot exposure in claim 8 wherein the left button to control the driver side mirror and the right button to control the passenger side mirror are connect by wireless means to a wireless signal receiver which is connected to the micro-controller, in order to activate the mirror movement mechanism either separately, simultaneously or concurrently.
